(19) United States
(12) Patent Application Publication
(10) Pub. No.: US 2017/0133907 A1
(43) Pub. Date: May 11, 2017

(54) ACTUATOR AND ELECTRONIC DEVICE HAVING THE SAME

(71) Applicant: MOATECH CO., LTD., Incheon (KR)

(72) Inventors: Yun CHOI, Incheon (KR); Byong-Jin PARK, Seoul (KR); Hoon-Hui WANG, Incheon (KR)

(21) Appl. No.: 15/321,983

(22) PCT Filed: Jun. 26, 2015
(86) PCT No.: PCT/KR2015/006594

§ 371 Date: Dec. 23, 2016

(30) Foreign Application Priority Data
Jun. 26, 2014 (KR) 10-2014-0078928
Jun. 24, 2015 (KR) 10-2015-0090009

(51) Int. Cl. H02K 7/00; H02K 5/10; B60L 1/14; B60Q 1/076

(52) U.S. Cl. CPC H02K 7/003; B60Q 1/076; H02K 5/10; B60L 1/14

(57) ABSTRACT

An actuator is provided, which includes a stator, a rotor passing through the stator and rotated in an interaction with the stator upon supply of external power, a driven body operating in accordance with a rotation of an axis of the rotor, a case surrounding the stator such that the axis of the rotor is protruded, and one or more rotation angle regulators installed on an outer side of the case and regulating a rotation angle of the rotor. Further, an electronic device having the actuator mentioned above is also provided.

### TECHNICAL FIELD

The present disclosure relates to an actuator, and more particularly, to an actuator capable of not only regulating a rotation angle of a rotor, but also providing ease of installation, and an electronic device having the same.

### BACKGROUND ART

Generally, various types of vehicles including automobiles or trucks are provided with a headlight in front, which is turned on to secure safe driving when vision is impaired at nighttime or under bad weather.

Conventionally, this headlight is separately provided with a front-faced lamp and a down-faced lamp such that during normal driving, the down-faced lamp is turned on, while the front-faced lamp is turned on under the certain circumstance when vision is impaired.

Accordingly, the headlamp for vehicle is set to operate in upward and downward rotational positions, and these positions are controlled by driving a separate actuator.

Further, a lamp assembly is connected to a rotating shaft provided in the actuator to be rotated such that the rotational position is determined in accordance with the rotational movement of the shaft.

Meanwhile, with a conventional technique, the rotation angle is adjusted by electronically regulating the rotational movement of the shaft. However, this can result in malfunction such that the rotation cannot be stopped accurately at the rotational position as set, in which case the problem arises where the shaft cannot return to the initial position.

Further, the actuator constructed as described above is installed on a certain corresponding object on the vehicle and secured to the actuator with separate fastening members, thus requiring increased space for installation, and the actuator itself also has an increased size.

For prior art, Korean Patent Publication No. 10-2012-0038754 (published on Apr. 24, 2012) can be referenced.

### DISCLOSURE

### Technical Problem

According to an embodiment, a technical objective is to provide an actuator having a stopper on an outer side of a case to regulate a rotation angle of a rotor fastened with a shade within a set range of rotation angle, and an electronic device having the same.

Another technical objective is to provide an actuator that, when installed at a corresponding position, reduces the overall size of a device and thus minimizes the installation space, and also achieves light-weight and compactness, and an electronic device having the same.

### Technical Solution

In a preferable aspect, an actuator is provided, which may include a stator, a rotor passing through the stator and rotated by interacting with the stator upon supply of external power, a driven body operating in accordance with a rotation of an axis of the rotor, a case surrounding the stator such that the axis of the rotor is protruded, and one or more rotation angle regulators installed on an outer side of the case and regulating a rotation angle of the rotor, in which the rotation angle regulators may be installed on both ends of the case.

The rotation angle regulators may preferably include a first stopper part installed on one end of the case, and a second stopper part installed on the other end.

The first stopper part may preferably include a groove formed in an outer side of the case and having a through hole through which the axis of the rotor is protruded, an elastic member disposed in the groove and forming an elastic force or a restoration elastic force in accordance with a rotation of the rotor, a cover disposed in the groove to cover the elastic member and secured to the axis of the rotor, and a first stopper formed on the cover and regulating the rotation angle of the rotor in rotating motion.

The actuator may preferably include a stopper guide groove formed on an outer side surface of the groove to regulate a movement of the first stopper.

The actuator may preferably include a spring securing groove formed in one side of the stopper guide groove, to receive one end of the elastic member being securely fit therein, in which the other end of the elastic member is secured on the axis of the rotor.

The cover may preferably have an axis securing hole through which the axis of the rotor is passed and secured.

The axis securing hole may preferably be formed in a D-cut shape.

The axis of rotor may preferably be formed into a shape corresponding to that of the axis securing hole.

The case may preferably include a pair of cases for coupling with hooks with each other.

The stator may preferably include a bobbin receiving part receiving therein a bobbin with coil wound thereon, and a rotor receiving part receiving therein the rotor with both ends of the rotor protruding.

The axis of the rotor may preferably be disposed to be protruded from one end or both ends of the case.

The second stopper part may preferably include a second stopper extended from the case and regulating the rotation angle of the driven body.

The driven body may preferably be securely coupled with the protruded both ends of the axis of the rotor.

Preferably, holes may be formed in both ends of the driven body, respectively, and the protruded axis of the rotor may be passed through each of the holes and securely coupled.

Preferably, the actuator may be rectangular and perform a rotary motion while being directly connected to an inner circumference of the driven body.

### Advantageous Effects

The present disclosure provides an effect that a rotation angle of a rotor fastened with a shade can be regulated within a set range of rotation angle, by installing a stopper on an outer side of a case.

Further, the present disclosure provides an effect that, when installed at a corresponding position, the overall size of a device is reduced, and thus the installation space is minimized, and also light-weight and compactness are achieved.

### DESCRIPTION OF DRAWINGS

FIG. 1 is a perspective view illustrating an actuator in an assembled state according to a first exemplary embodiment of the present disclosure.

FIG. 2 is an exploded perspective view illustrating an actuator according to the present disclosure.

FIG. 3 illustrates a relationship in which a case and a stator are coupled with each other, according to the present disclosure.

FIGS. 4 and 5 are views illustrating a rotation angle regulator according to the present disclosure.

FIG. 6 is a view illustrating an elastic member in installed state.

FIG. 7 is a perspective view illustrating a relationship in which a yoke and a bobbin are coupled with each other, according to a second exemplary embodiment of the present disclosure.

FIG. 8 is a view illustrating a relationship in which a bobbin hollow portion exposed from cuts of a case and a yoke are coupled with each other according to the present disclosure.

FIG. 9 is a top view illustrating a relationship in which a case and a yoke are coupled with each other according to the present disclosure.

FIG. 10 is a view illustrating a magnetic path formed by coupling of bobbin and yoke according to the present disclosure.

FIG. 11 is a perspective view illustrating another example of an actuator according to the present disclosure.

FIG. 12 is a front view illustrating the actuator of FIG. 11.

FIG. 13 is a perspective view illustrating a first stopper part according to the present disclosure.

FIG. 14 is a perspective view illustrating a second stopper part according to the present disclosure.

FIG. 15 is a side view illustrating a state in which a rotation angle of a driven body is regulated by the second stopper part according to the present disclosure.

### BEST MODE

Hereinbelow, an actuator and an electronic device having the same will be described with reference to the accompanying drawings.

### First Exemplary Embodiment

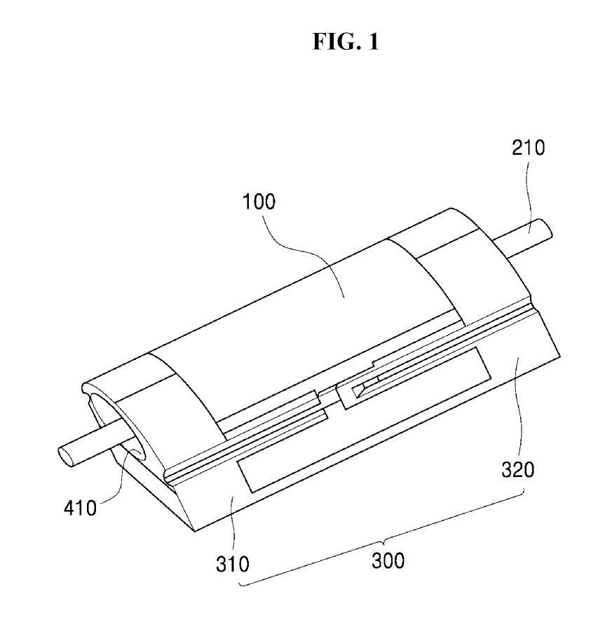

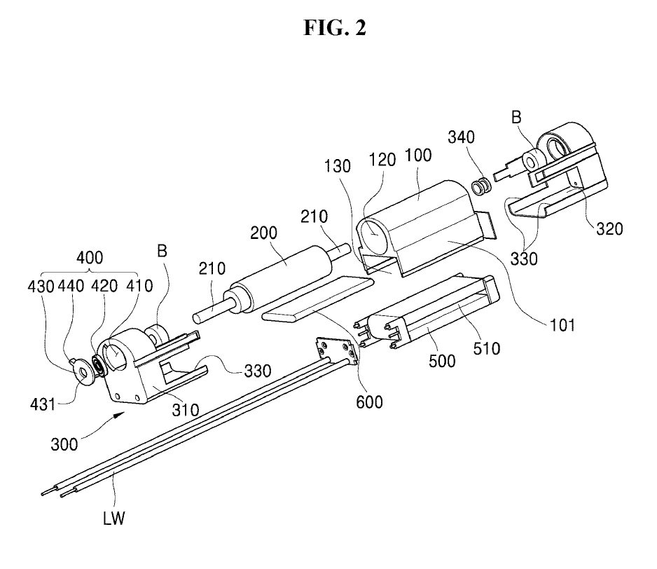

FIG. 1 is a perspective view illustrating an actuator in an assembled state according to a first exemplary embodiment of the present disclosure, and FIG. 2 is an exploded perspective view illustrating an actuator according to the present disclosure.

Referring to FIGS. 1 and 2, the actuator according to the present disclosure mainly includes a stator 100, a rotor 200, a case 300, and a rotation angle regulator 400.

Hereinbelow, each of the configurations will be described.

Stator 100

The stator 100 has a hollow form. The hollow part is a rotor receiving part 120 disposed to receive the rotor 200 inserted therein.

The stator 100 is formed into a stack structure.

The stator 100 is open at a lower end in front and back directions along a length direction of the stator 100, and has a bobbin receiving part 110 having a mount space formed therein.

A bobbin 500 with coils wound thereon is inserted and installed in the bobbin receiving part 110.

In an example, the bobbin 500 has a bobbin hollow part 510, and the bobbin hollow part 510 is formed into a shape extended through the bobbin 500.

The bobbin hollow part 510 is formed along a direction orthogonal to a direction of axis of the rotor 200 which will be described below.

A plate-type yoke 600 (to be described) is inserted and installed in the hollow part 510 of the bobbin 500.

In an example, the yoke 600 is in a state of being inserted into the bobbin hollow part 510, and the bobbin 500 described above may be positioned in the bobbin receiving part 110 formed in the stator 100 such that both sides are covered.

Additionally, the bobbin 500 is electrically connected to a lead wire LW to be supplied with external power.

Rotor 200

According to the present disclosure, the rotor 200 is installed by being rotatably fit in the rotor receiving part 120 formed in the stator 100.

The axes 210 formed on both ends of the rotor 200 are protruded along both sides of the stator 100.

One end, or both ends of the axis 210 of the axes 210 of the rotor 200 may be so formed that the cross section has ‘D’ shape.

A rotational axis of the rotor 200 may be formed as the rotor 200 is fit in the rotor receiving part 120 formed in the stator 100 as described above, and the rotor 200 may be rotated with rotational velocity set by an interaction with the stator 100 according to a supply of the external power.

Case 300

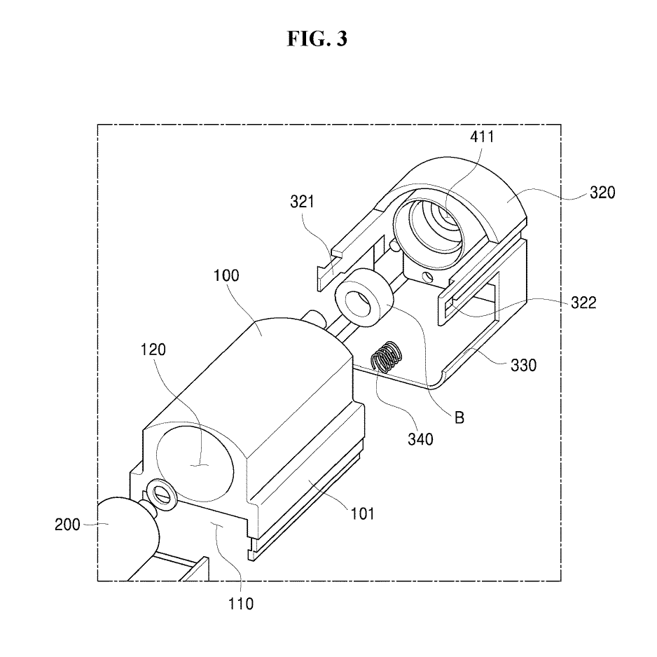

FIG. 3 illustrates a relationship in which a case and a stator are coupled with each other, according to the present disclosure.

Referring to FIGS. 2 and 3, the case 300 according to the present disclosure includes first and second cases 310, 320.

The first and second cases 310, 320 may be disposed to face each other, and may be coupled by hooks with each other.

For example, one, or a plurality of protruding hooks 311 may be formed on an end of the first case 310, and one, or a plurality of hook holes 321 for coupling with the hooks 311 may be formed on an end of the second case 320.

Further, pairs of hooks 311 and hook holes 321 may be installed on the first and second cases 310, 320.

The first and second cases 310, 320 may be configured to be coupled with hooks, and surround the stator 100 described above.

Further, both ends of the axis 210 of the rotor 200 disposed to penetrate the stator 100 are passed through and protruded outside the first and second cases 310, 320.

Meanwhile, at least one or more springs 340 are respectively disposed on a connecting part formed between the stators 100 and the first and second cases 310, 320.

Accordingly, when the first and second cases 310, 320 are coupled with hooks with each other, the spring 340 interposed between the first and second cases 310, 320 and the stator 100 is compressed such that the compression force therefrom increases the hook fastening torque.

Further, cuts 330 are formed by cutting both sides of the case 300 coupled as described above.

The cuts 330 may be holes for guiding insertion of the yoke 600 into the bobbin hollow part 510.

Rotation Angle Regulator 400

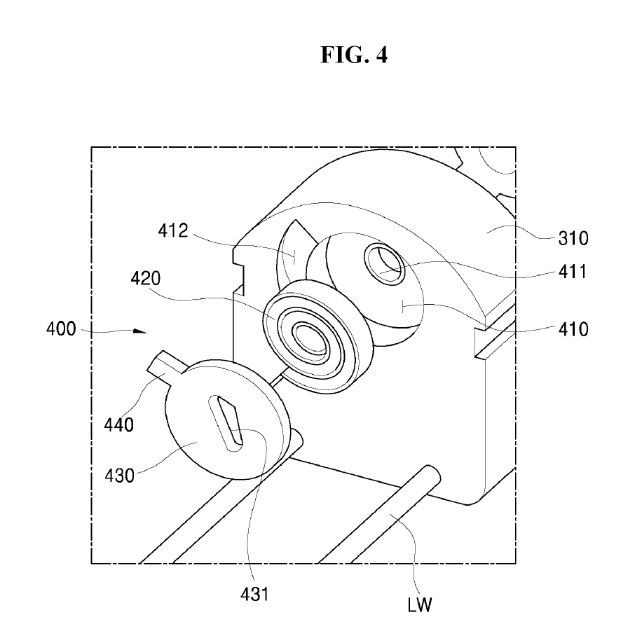

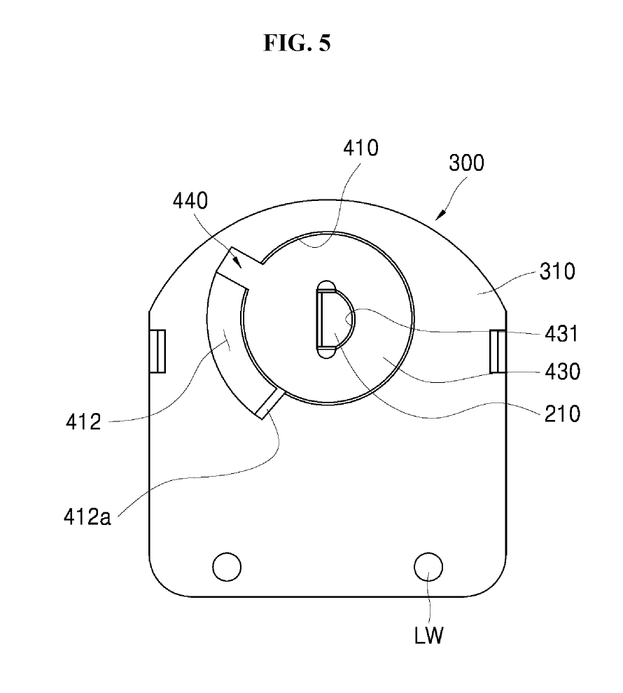

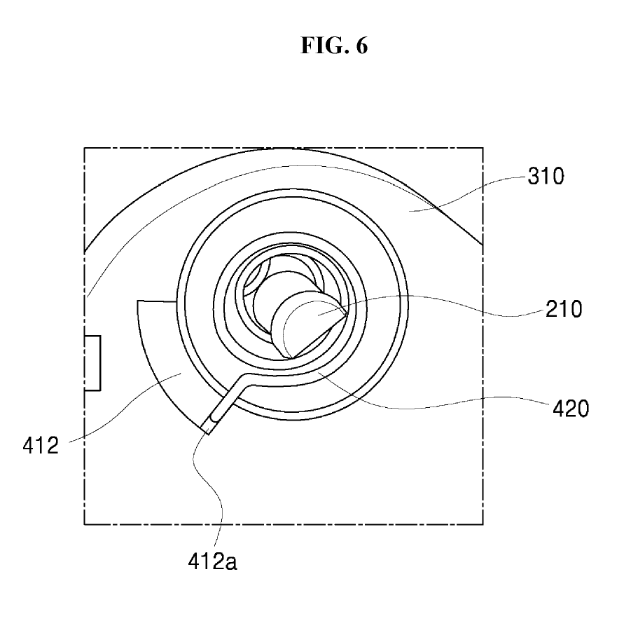

FIGS. 4 and 5 are views illustrating a rotation angle regulator according to the present disclosure, and FIG. 6 is a view illustrating an elastic member in installed state.

Referring to FIGS. 4 and 5, the rotation angle regulator 400 according to the present disclosure mainly includes a groove 410, an elastic member 420, a cover 430, and a stopper 440.

The groove 410 may be formed on one or both of outer surface of the first case 310 and an outer surface of the second case 320.

The groove 410 includes a through hole 411 formed therein, and the axis 210 of the rotor 200 is passed through the through hole 411. The groove 410 may preferably be a groove having a set radius.

The elastic member 420 is disposed in the groove 410.

Preferably, the elastic member 420 is formed into spiral shape, and compressed when rotated to one side, and returned to original position by the restoration elastic force when rotated to the other side upon removal of the rotating force.

One end of the elastic member 420 is secured to the axis 210 of the rotor 200 protruding through the through hole 411.

Meanwhile, the cover 430 is rotatably disposed in the groove 410 to cover the groove 410 where the elastic member 420 is disposed.

An axis securing hole 431 is formed at a center of the cover 430. The axis securing hole 431 receives the axis 210 of the rotor 200 passed therethrough and secures the axis 210 of the rotor 200 passed therethrough.

Further, the cover 430 may prevent the elastic member 420 from separating outside, by covering the groove 410.

In an example, the axis securing hole 431 may preferably be formed in D-cut shape which is identical to a cross sectional shape of the axis 210 of the rotor 200.

Accordingly, the cover 430 covering the groove 410 is preferably rotated in accordance with the axis 210 of the rotor 200.

Further, the stopper 440 that protrudes outwardly may be formed on an outer circumference of the cover 430.

In an example, the stopper 440 is formed integrally with the cover 430.

In addition, a stopper guide groove 412 for guiding the movement of the stopper 440 is formed on the outer circumference of the groove 410.

The stopper guide groove 412 is formed along a perimeter of the groove 410.

Accordingly, the rotation angle of the stopper 440 protruding from the outer circumference of the cover 430 may be regulated as much as a length of the circumference of the stopper guide groove 412, while the stopper 440 is positioned in the stopper guide groove 412.

Moreover, a spring securing groove 412a is formed on one side of the stopper guide groove 412.

The other end of the elastic member 420 is securely fit in the spring securing groove 412a.

Accordingly, one end of the elastic member 420 is secured to the axis 210 of the rotor 200, and the other end is securely fit in the spring securing groove 412a.

Further, the axis 210 of the rotor 200 protruding through both sides of the case 300 as described above is connected to a shade (not illustrated).

Accordingly, the shade may be rotated in accordance with the rotation of the axis 210 of the rotor 200.

When the operation is ON with supply of external power by the configuration described above, the rotor 200 is rotated in a forward direction by an interaction with the stator 100.

At this time, the axis 210 of the rotor 200 is also rotated, and the cover 430 connected to the axis 210 of the rotor 200 is rotated in accordance with the rotation of the axis 210 of the rotor 200.

Further, the elastic member 420, which is positioned in the groove 410 of the case 300 with one end being secured to the axis 210 of the rotor 200 and the other end being secured to the spring guide groove 412a, is rotated to the expanded state. At this time, the elastic member 420 forms a predetermined restoration elastic force.

Simultaneously, the stopper 440 protruding from the outer circumference of the cover 430 is rotated along the stopper guide groove 412a to regulate the rotation angle of the axis 210 of the rotor 200 along the length of the circumference of the stopper guide groove 412a.

When power is OFF, the axis 210 of the rotor 200 may then be counter-rotated by the restoration elastic force of the elastic member 420 to be returned to the original position.

Accordingly, the rotation angle of the axis 210 of the rotor 200 is regulated with the stopper 440, and the rotation into the original position may be achieved by the restoration elastic force of the elastic member 420.

According to the present disclosure, the rotation angle regulator 400 as described above may be installed on one side or both sides of the case 300 to perform the function described above.

Further, since the shade (not illustrated) is directly connected to both ends of the axis 210 of the rotor 200 according to the present disclosure, the driving structure of the shade can be simplified and compactness and light-weight of the actuator and the electronic device can be achieved.

Further, according to the present disclosure, because the axis 210 of the rotor 200 is returned to the original position by using the elastic member 420 as a restoring spring, the mechanical shortcoming that the rotor 200 is not rotated to the original position successfully can be fundamentally resolved.

### Second Exemplary Embodiment

The second exemplary embodiment of the present disclosure will be described below, while the same configurations as those described above with reference to the first exemplary embodiment will be omitted for the sake of clarity.

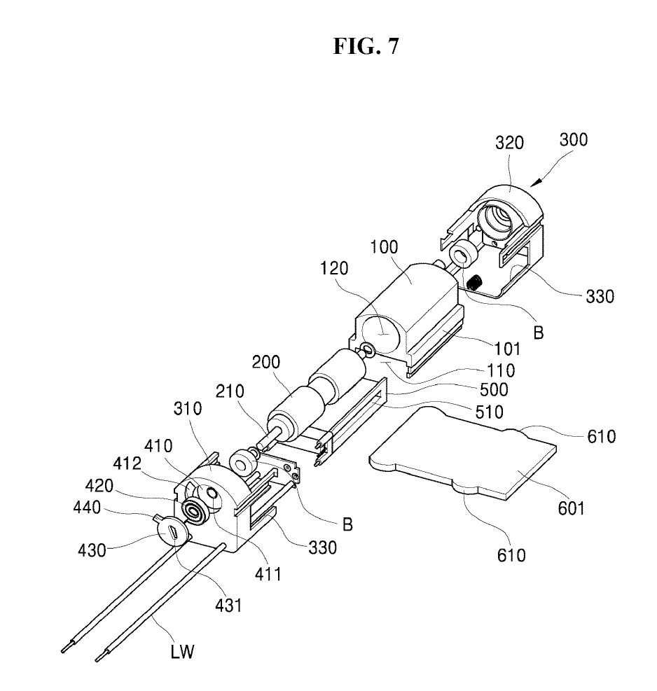

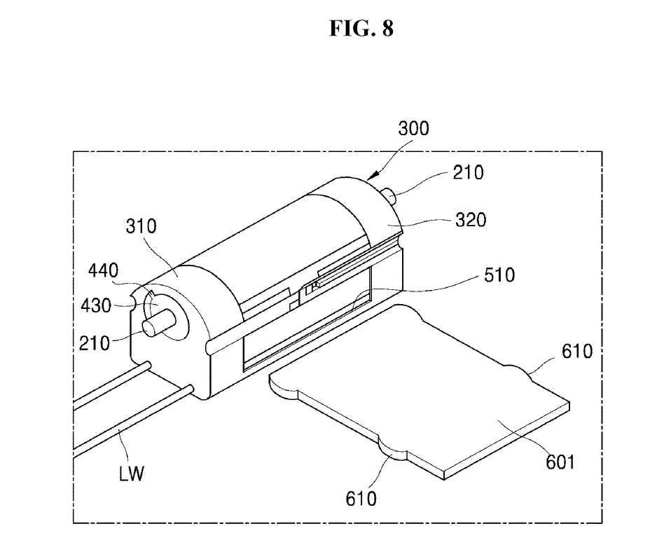

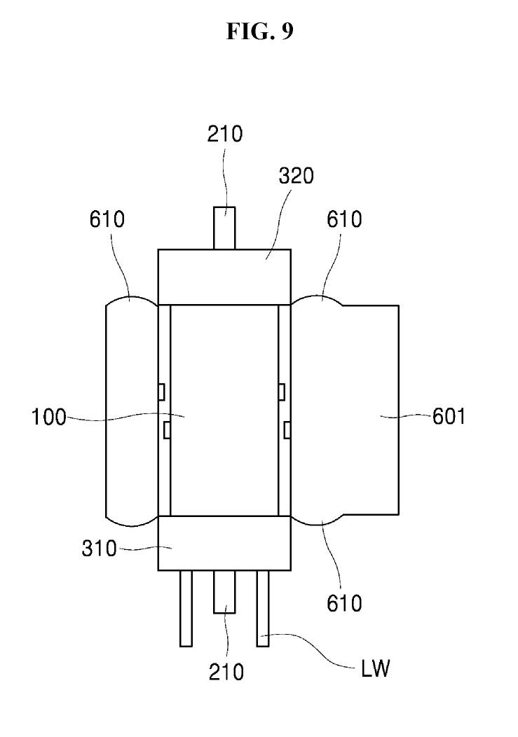

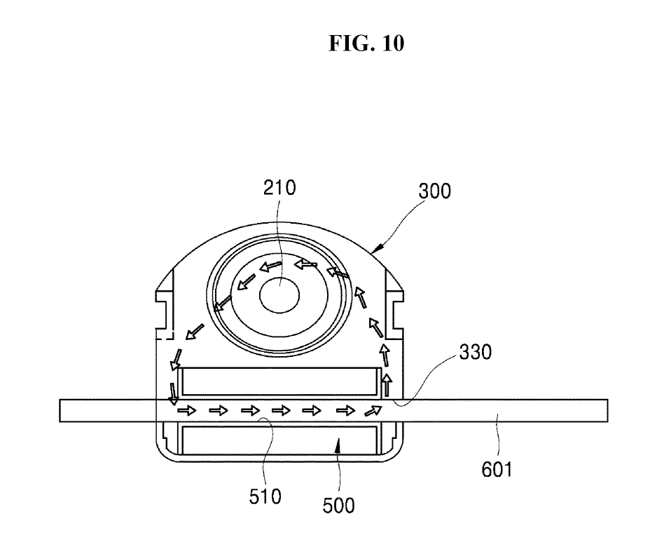

FIG. 7 is a perspective view illustrating a relationship in which a yoke and a bobbin are coupled with each other, according to a second exemplary embodiment of the present disclosure, FIG. 8 is a view illustrating a relationship in which a bobbin hollow portion exposed from cuts of a case and a yoke are coupled with each other according to the present disclosure, FIG. 9 is a top view illustrating a relationship in which a case and a yoke are coupled with each other according to the present disclosure, and FIG. 10 is a view illustrating a magnetic path formed by coupling of bobbin and yoke according to the present disclosure.

Referring to FIGS. 7 to 10, cuts 330 are formed on both sides of the case 300.

Further, a bobbin receiving part 110, surrounded by sidewalls 101′ on both sides, is formed on a lower end of the stator 100.

A bobbin 500 having bobbing hollow portions 510 passed through both sides is received in the bobbin receiving part 110.

In an example, the sidewalls 101 of the stator 100′ are partially cut to expose the bobbin hollow portion 510 outside.

In an example, the sidewalls 101 of the stator 100 may be cut at a lower end and positioned above the bobbin hollow portion 510 to expose the bobbin hollow portion 510 outside, or it is of course possible that the sidewalls 101 are partially cut to form an exposure hole that exposes the bobbin hollow portion 510 outside.

In an example, the bobbin hollow portion 510 formed in the bobbin 500 by the cuts 330 may be exposed outside, and both ends of the yoke 600 fit in the bobbin hollow portion 510 are passed through the cuts 330 of the case 300 and protruded to be exposed from both sides of the case 300.

According to the present disclosure, the yoke 600 is formed in a plate shape.

The yoke 600 formed as described above is fit through the cut 330 formed in the case 300, passed through the bobbin hollow portion 510 of the bobbin 500 received in the bobbin receiving part 110′, and passed through the cut 330 positioned on the other side.

Accordingly, the yoke 600 is maintained as being fit in the bobbin hollow portion 510 of the bobbin 500, and both ends of the yoke 600 are passed through the cuts 330 and protruded from both sides of the case 300.

In an example, one or more positioning protrusions 610 that protrude outwardly are formed on both side surfaces of the yoke 600.

The positioning protrusions 610 may be protruded outwardly from the yoke 600, with the protruding surface preferably forming a curved surface.

Preferably, a plurality of positioning protrusions 610 are formed on both side surfaces of the yoke 600 at a regular interval.

The positioning protrusions 610 formed as described above may be locked with the cuts 330 and the inner walls of the hollow portion 510 of the bobbin 500.

Accordingly, when the yoke is fit in the hollow portion of the bobbin 500, the yoke is passed through the bobbin hollow portion and thus can prevent movement of the actuator itself

Meanwhile, sealing (not illustrated) may be additionally provided between the bobbin hollow portion 510 and the yoke 600 fit in the bobbin hollow portion 510.

The sealing is used for making the space between the bobbin hollow portion 510 and the yoke 600 waterproof.

Additionally, a hole or groove, or a protrusion (not illustrated) may be formed on the yoke 600 for securing with a corresponding external object.

Preferably, the hole or groove, or the protrusion may be formed on both ends of the yoke 600 that protrudes outwardly from both sides of the case 300.

Although not illustrated, in a representative example, when the protrusion is formed on the yoke, the protrusion is fit in a fastening groove that is formed in the corresponding object to receive a protrusion.

Accordingly, the yoke 600 is secured on the corresponding object without requiring separate fastening members, and the installation process for the actuator can be simplified.

With the configuration described above, because the yoke having positioning protrusions on one side surface or both side surfaces are securely fit in the hollow portion of the bobbin, when the positioning protrusions are inserted into the cuts and the hollow portion of the bobbin, the bobbin is expanded to be compressed in both the radial and thrust directions, and thus can be secured in position without having clearance.

Further, the yoke is formed as a magnetic body that serves as a magnetic path, and the plate-type yoke with its simple structure can be applied in a variety of applications.

Further, since a groove or hole, or a protrusion that can be coupled with a corresponding object is formed on the yoke, compared to the conventional structure requiring increased weight due to need for fastening holes formed in the case or the housing of the actuator and bolts for fastening therewith, the present disclosure can effectively prevent weight increase.

Further, since the yoke is used as one of the fastening means as described above, the actuator can be compact-sized, light-weighted, and fastened with simple method, and effect such as improved workability and reduced production cost is obtained. Further, the simple fastening method allows use in a variety of applications, and ease of maintenance and repair.

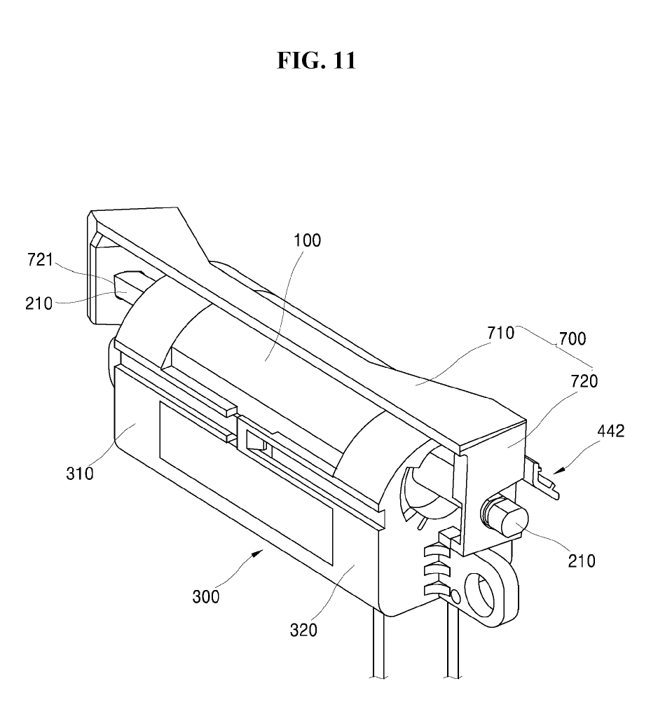

Next, the actuator of another example according to the present disclosure will be described with reference to FIGS. 11 to 15.

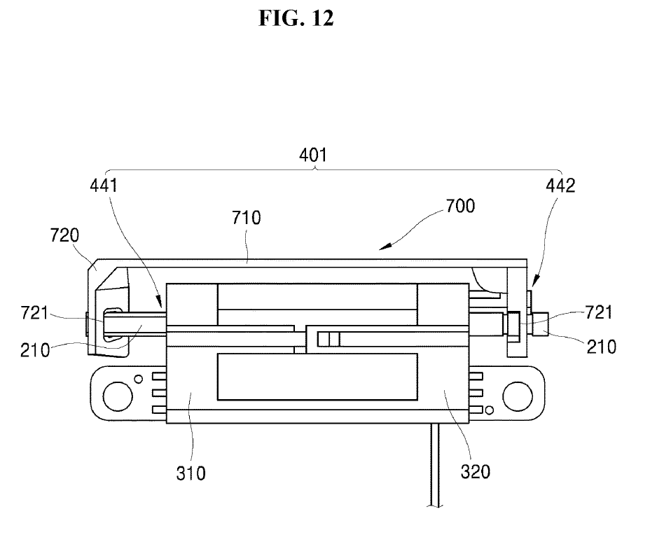

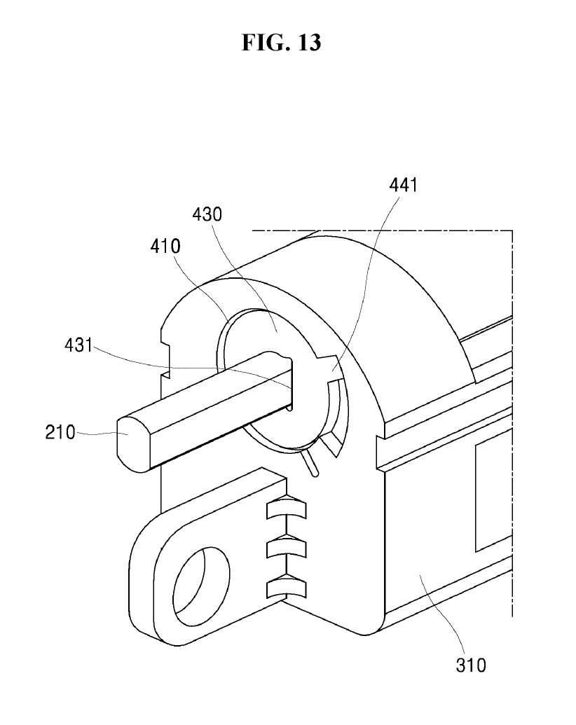

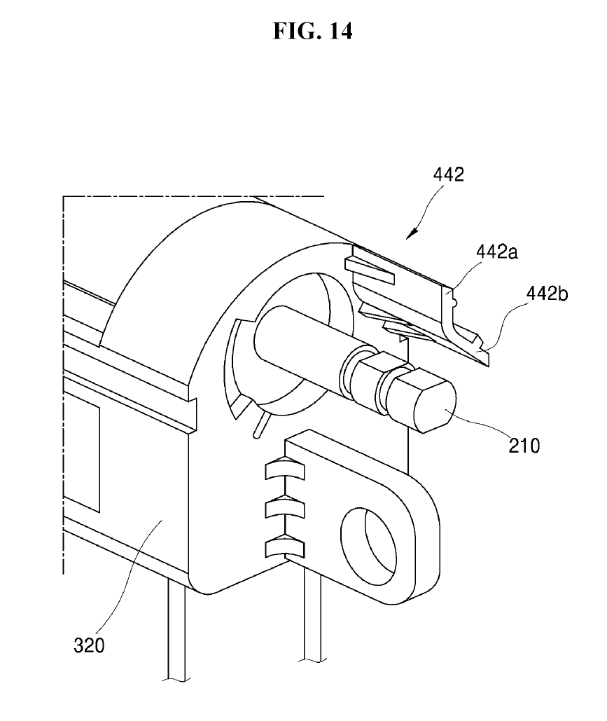

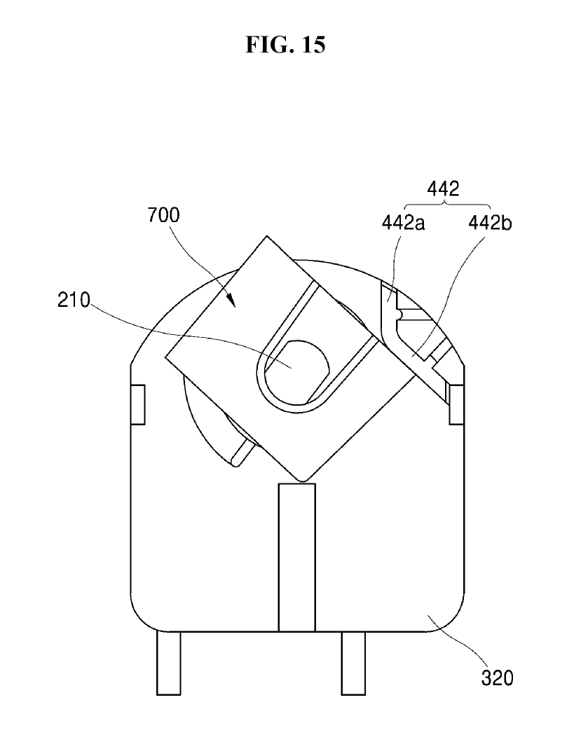

FIG. 11 is a perspective view illustrating another example of an actuator according to the present disclosure, FIG. 12 is a front view illustrating the actuator of FIG. 11, FIG. 13 is a perspective view illustrating a first stopper part according to the present disclosure, FIG. 14 is a perspective view illustrating a second stopper part according to the present disclosure, and FIG. 15 is a side view illustrating a state in which a rotation angle of a driven body is regulated by the second stopper part according to the present disclosure.

Referring to FIGS. 11 and 12, the actuator according to the present disclosure includes a stator 100, a rotor 200, a driven body 700, a case 300, and a rotation angle regulator 401.

The configurations of the stator 100, the rotor 200, and the case 300 are overlapped with the description provided above and will not be redundantly described below.

The rotation angle regulator 401 is formed on both ends of the case 300.

More specifically, the rotation angle regulator 401 includes a first stopper part and a second stopper part.

Referring to FIG. 13, the first stopper part is formed on an outer side of the first case 310, and includes a groove 410 having a through hole 411 through which the axis 210 of the rotor 200 is protruded (see FIG. 4), an elastic member 420 disposed in the groove 410 to form an elastic force or a restoration elastic force in accordance with a rotation of the rotor 200 (see FIG. 4), a cover 430 disposed in the groove 410 to cover the elastic member 420 and secured to the axis 210 of the rotor 200, and a first stopper 441 formed on the cover 430 and regulating a rotation angle of the rotor 200 in rotating motion.

In an example, the first stopper 441 may have substantially the same configuration of the stopper 440 described above with reference to FIGS. 1 to 10.

The first stopper 441 is formed to protrude from an outer circumference of the cover 430, and a stopper guide groove 412 is formed on an outer side surface of the groove 410, to regulate a movement of the first stopper 441.

Meanwhile, referring to FIGS. 14 and 15, the second stopper part includes a second stopper 442 extended from an outer surface of the second case 320 to regulate a rotation angle of the driven body 700.

In an example, referring to FIGS. 11 and 12, both ends of the driven body 700 are securely coupled with both ends of the axis 210 of the rotor 200, in which one end is protruded from a side of the first case 310 and the other end is protruded from a side of the second case 320.

The driven body 700 includes a plate-type upper plate 710 disposed above the case 300, and a pair of side plates 720 bent at right angles on both ends of the upper plate 710.

A hole 721 is formed on each of the pair of side plates 720.

One end of the axis 210 of the rotor 200, which protrudes from the side of the first case 310, is passed through the hole 721 formed on one end of the driven body 700 and securely coupled, and the other end of the axis 210 of the rotor 200, which protrudes from the side of the second case 320, is passed through the hole 721 formed on the other end of the driven body 700 and securely coupled.

In an example, the overall shape of the driven body 700 is ‘D’, and the driven body 700 is rotatable while being disposed in a position of covering the upper portion of the case 300.

Further, as illustrated in FIGS. 11 and 14, the second stopper 442 is formed in a plate shape and has the overall ‘L’ shape.

The second stopper 442 may include an attaching member 442a, and a regulating member 442b extended from an end of the attaching member 442a and bent.

The second stopper 442 is disposed at a position of moving along a path of rotation of the driven body 700, and the attaching member 442a is attached onto an outer surface of the second case 320. As illustrated in FIG. 15, the regulating member 442b may regulate the rotation angle of the driven body 700 upon being brought into contact with one surface of the rotating driven body 700.

Accordingly, the present disclosure installs two stoppers 441, 442 to regulate the rotation angle of the driven body on both ends and thus provides an advantage of stably regulating the rotation angle of the rotating driven body 700.

Further, even when one of the first stopper 441 and the second stopper 442 is damaged, the other undamaged stopper is used to regulate the rotation angle of the driven body 700. Accordingly, the present disclosure provides an advantage that the lifespan of the normal operation of the actuator can be extended.

Moreover, although not illustrated, without the first stopper 441, i.e., when only the second stopper 442 is present, the position of the attaching member 442a on the outer surface of the second case 320 can be modified to change and regulate the rotation angle of the driven body 700.

The actuator and the electronic device having the same according to the present disclosure have been described above with reference to detailed exemplary embodiments. However, it is apparent that various modifications of embodiments are possible without departing from the scope of the claims.

Therefore, the scope of the present disclosure should not be limited to the foregoing exemplary embodiments and advantages, but defined by not only the accompanying claims, but also equivalents to the claims.

That is, the foregoing exemplary embodiments are merely exemplary and are not to be construed as limiting the exemplary embodiments, and the scope of the present disclosure is represented by the accompanying claims, and meaning and breadth of the claims, and all the modifications or modified forms derived from the equivalent concept thereof should be interpreted as being included in the scope of the present disclosure.

1. An actuator, comprising:
a stator;
a rotor passing through the stator and rotated by interacting with the stator upon supply of external power;
a case surrounding the stator such that an axis of the rotor is protruded; and
one or more rotation angle regulators installed on an outer side of the case and configured to regulate a rotation angle of the rotor, wherein, after the rotor is rotated, the rotation angle regulators cause the rotor to return an initial position under elastic recovery force by using an elastic member connected to the axis of the rotor protruding from one end of the case.

2. An electronic device comprising the actuator of claim 1.

3. The actuator of claim 1, wherein the rotation angle regulators comprise a first stopper part installed on one end of the case, and a second stopper part installed on other end.

4. The actuator of claim 3, wherein the first stopper part comprises:
a groove formed in an outer side of the case and having a through hole through which the axis of the rotor is protruded;
an elastic member disposed in the groove and forming an elastic force or a restoration elastic force in accordance with a rotation of the rotor;
a cover disposed in the groove to cover the elastic member and secured to the axis of the rotor; and
a first stopper formed on the cover and regulating the rotation angle of the rotor in rotating motion.

5. The actuator of claim 4, comprising a stopper guide groove formed on an outer side surface of the groove to regulate a movement of the first stopper.

6. The actuator of claim 5, comprising a spring securing groove formed in one side of the stopper guide groove, to receive one end of the elastic member being securely fit therein,
wherein other end of the elastic member is secured on the axis of the rotor.

7. The actuator of claim 4, wherein the cover has an axis securing hole through which the axis of the rotor is passed and secured,
the axis securing hole is formed in a D-cut shape, and
the axis of rotor is formed into a shape corresponding to that of the axis securing hole.

8. The actuator of claim 1, wherein the case comprises a pair of cases for coupling with hooks with each other.

9. The actuator of claim 1, wherein the stator comprises:
a bobbin receiving part receiving therein a bobbin with coil wound thereon; and
a rotor receiving part receiving therein the rotor with both ends of the rotor protruding.

10. The actuator of claim 1, wherein the axis of the rotor is disposed to be protruded from one end or both ends of the case.

11. The actuator of claim 3, wherein the second stopper part comprises a second stopper extended from the case and regulating the rotation angle of a driven body which is operated in accordance with the rotation of the axis of the rotor.

12. The actuator of claim 1, wherein the driven body is securely coupled with the protruded both ends of the axis of the rotor.

13. The actuator of claim 12, wherein holes are formed in both ends of the driven body, respectively, and
the protruded axis of the rotor is passed through each of the holes and securely coupled.

14. The actuator of claim 1, wherein the actuator is rectangular and performs a rotary motion while being directly connected to an inner circumference of the driven body.
